(19) United States
(12) Patent Application Publication
(10) Pub. No.: US 2008/0297294 A1
(43) Pub. Date: Dec. 4, 2008

(54) Package Structure for an Inductance Element

(75) Inventors: Jun Wang, Tai Xing City (CN); Xinhua Li, Dongguan City (CN)

Correspondence Address: GROSSMAN, TUCKER, PERREAULT & PFLEGER, PLLC, 55 SOUTH COMMERICAL STREET, MANCHESTER, NH, 03101, US

(73) Assignee: DELTA ELECTRONICS, INC., Taoyuan Hsien (TW)

(21) Appl. No.: 11/868,053

(22) Filed: Oct. 5, 2007

(30) Foreign Application Priority Data
May 29, 2007 (TW) 096119126

(51) Int. Cl. H01F 27/02

(52) U.S. Cl. 336/90

(57) ABSTRACT

A package structure for an inductance element is provided. The package structure comprises a casing, a plurality of conductive terminals, a lid, and a positioning device. The casing has two opposite first sidewalls and two opposite second sidewalls, all of which define a receiving space for receiving the inductance element. Each conductive terminal has an upper end and a lower end. The upper ends extend from an upper portion of one of the first sidewalls, and are located in a recess defined by the two opposite second sidewalls to electrically connect to the inductance element. The lower ends extend from a lower portion of the first sidewalls and are adapted to electrically connect to a circuit board. The lid is configured to cover the inductance element. The positioning device is disposed between the lid and at least one of the first sidewalls to position the lid onto the casing.

This application claims priority to Taiwan Patent Application No. 096119126 filed on May 29, 2007, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a package structure; and more particularly, the present invention relates to a package structure for an inductance element.

2. Descriptions of the Related Art

With the technical advancement in the semiconductor processing field and increasing integrated circuit density, the number of pins of electronic devices is increasing continuously. The market demand for small sized products has resulted in the production of electronic device packages with reduced volume. As an integral element in various electronic devices, inductors cannot be removed from the electronic device packages during volume reduction. As a result, all relevant entities in this field are now actively engaged in reducing the package size of inductors.

A conventional package structure for combined inductors is depicted in FIGS. 1A and 1B, which show a top view and a bottom view of the package structure, respectively. The package structure comprises a casing 10 that has an enclosed structure on the top and an open structure on the bottom. Both sides together define a receiving space. Two rows of buried pins 11 are provided respectively on the inside of the two side frames of the casing 10 near the open structure. During the packaging process, an adhesive has to be applied to the magnetic coil for adhering it into the receiving space. The buried pins 11 are electrically connected to the magnetic coil via a solder. Furthermore, two rows of patch pins 12 are provided on the outside of the open structure, so that the combined inductor can be electrically connected to a printed circuit board. Unfortunately, the open bottom of such a package structure requires the magnetic coil to be fixed within the casing 10 using an adhesive, which will inevitably consume additional labor, material and cost.

FIG. 2A is an exploded view of another conventional package structure for a combined inductor. This structure is comprised of an upper cover 20 and a bottom frame 21 connected together. FIG. 2B is a top view of this structure after assembled. Unfortunately, since the lid 20 is rectangular with fixed height, this package structure is large and thus, occupies a large space.

In summary, the conventional package structures have the following disadvantages. Firstly, given the same volume of internal devices, products adopting the conventional package structures possess a larger volume. Secondly, in actual use, the open bottom of such package structures requires the magnetic coils to be fixed within the casings using an adhesive, which will inevitably consume additional material and costs. Thirdly, if no assembling apparatus is available for automatic assembly, the narrow spacing between the neighboring pins is more likely to cause short-circuit failures during the process of soldering such inductors to the circuit boards. Finally, such conventional package structures are not reliable and are subject to broken-line failures during vibrations. In modern society where electronic devices are increasingly lighter, slimmer, and smaller, such disadvantages often lead to poor quality, high costs, and low yields. Accordingly, it is still an objective to improve the reliability and reduce the space occupation of the package structures in this field.

### SUMMARY OF THE INVENTION

The objective of this invention is to provide a package structure for an inductance element. This package structure replaces the conventional rectangular lid structure with a sheet structure to reduce the height thereof, and further allows electronic elements to be placed directly into the receiving space of its casing for soldering. As a result, the package can be downsized substantially and there is sufficient space available for assembling and soldering the internal electronic devices therein. Due to the large space available for installation, this package structure is free of short-circuit failure in the coil even under installation conditions of the lead-free IR reflowing process. Additionally, installation of the magnetic coil in the receiving space provides for a more stable and reliable package. Thus, disadvantages found in conventional package structures can be eliminated completely so that these package structures can also become increasingly lighter, slimmer and smaller.

A package structure disclosed in this invention comprises a casing, a plurality of conductive terminals, a lid, and a positioning device. The casing has two opposite first sidewalls and two opposite second sidewalls, all of which define a receiving space for receiving an inductance element. Each conductive terminal has an upper end and a lower end. The upper ends extend from an upper portion of each first sidewall, and are located in an area defined by the two opposite second sidewalls to electrically connect to the inductance element. The lower ends extend from a lower portion of each first sidewall and are adapted to electrically connect to a circuit board. The lid is configured to cover the inductance element. The positioning device is disposed between the lid and at least one of the first sidewalls to position the lid onto the casing.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a top view of a conventional package structure;

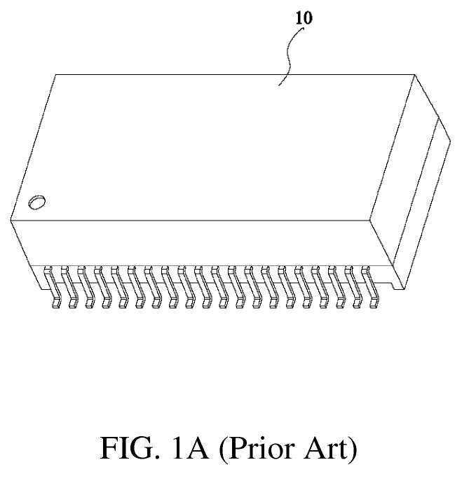

FIG. 1B is a bottom view of the package structure shown in FIG. 1B;

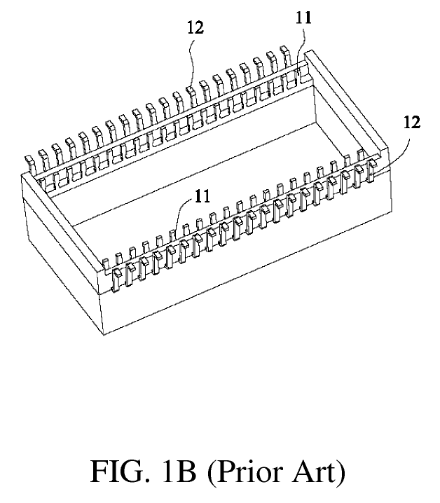

FIG. 2A is an exploded view of another conventional package structure;

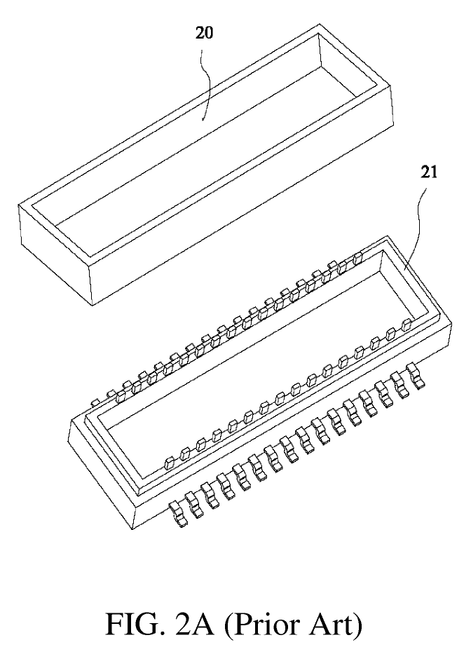

FIG. 2B is a schematic view of the conventional package structure shown in FIG. 2A in an engaged state;

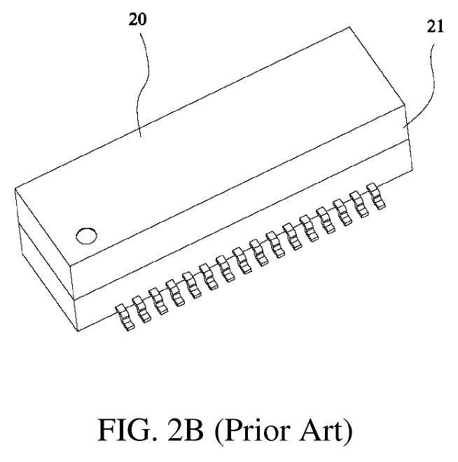

FIG. 3A is an exploded view of a package structure in a preferred embodiment of this invention; and

FIG. 3B is a schematic view of the package structure shown in FIG. 3A in an engaged state.

### DESCRIPTION OF THE PREFERRED EMBODIMENT

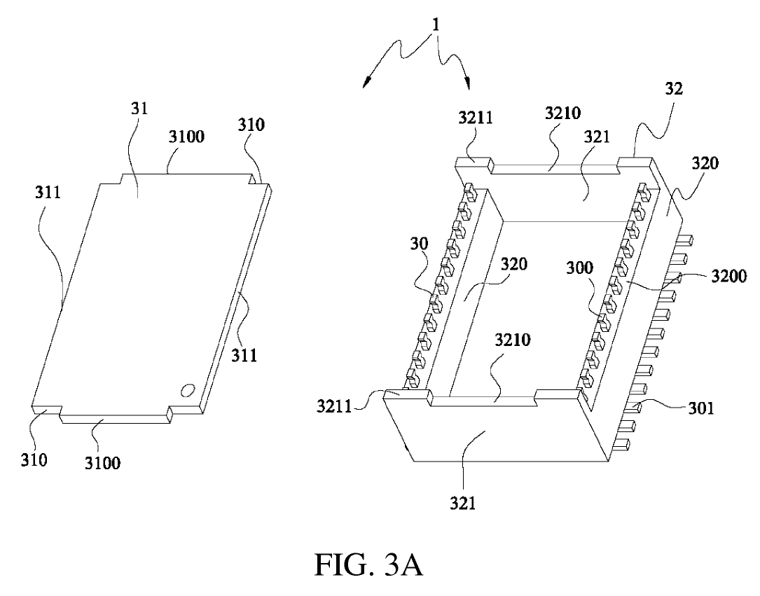

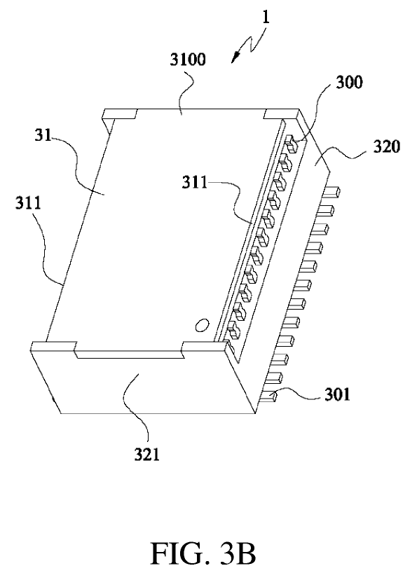

FIG. 3A illustrates an exploded view of a package structure 1 in a preferred embodiment of this invention. The package structure 1 is configured to package an inductance element (not shown), and comprises a casing 32, a plurality of conductive terminals 30, a lid 31, and two sets of positioning devices. The casing 32 has two opposite first sidewalls 320 and two opposite second sidewalls 321, all of which define a receiving space for receiving the inductance element. Furthermore, each conductive terminal 30 has an upper end 300 and a lower end 301. The upper ends 300 extend from an upper portion 3200 of the first sidewalls 320, and are located in an area defined by the two opposite second sidewalls 321 to electrically connect to the inductance element in the receiving space. The lower ends 301 extend from a lower portion (not shown) of the first sidewalls 320 and are adapted to electrically connect to a circuit board (not shown). Specifically, the upper end 300 of each conductive terminal 30 extends from an upper surface of the first sidewalls 320, while the lower end 301 extends from a lower surface of the first sidewalls 320. Additionally, in this preferred embodiment, the circuit board is a printed circuit board, while each of the conductive terminals is a pin.

Continuing to refer to FIG. 3A, the lid 31 of the package structure 31 is a sheet structure and is configured to cover the inductance element in the receiving space. In particular, the lid 31 has two opposite first sidewalls 310 and two opposite second sidewalls 311. The positioning devices are disposed between the first sidewalls 310 of the lid 31 and the second sidewalls 321 of the casing 32 to position the lid 31 onto the casing 32. Each set of positioning devices has a convex portion 3100 formed on a corresponding first sidewall 310 of the lid 31 and a matching concave portion 3210 formed on a top surface 3211 of a corresponding second sidewall 321 of the casing 32. In other embodiments, the positioning devices may be formed only on one first sidewall 310 and a top surface 3211 of one corresponding second sidewall 321 on the same side. That is, there may be only one set of convex 3100 and concave 3210 portions in the positioning devices. Of course, the package structure 1 may also have more than one set of position devices, in order to strengthen engagement between the lid 31 and the casing 32.

FIG. 3B is a schematic view of the package structure 1 in an engaged state. Once the lid 31 is engaged with the casing 32, a convex portions 3100 in the two first sidewalls 310 of the lid 31 are mated with a concave portions 3210 on the top surfaces 3211 of the two second sidewalls 321 of the casing 32, with the lid 31 just covering the inductance element. Moreover, the two second sidewalls 311 of the lid 31 are adapted to define a space within the conductive terminals 30 so that physical contact can be avoided substantially

Accordingly, to assemble an inductance element with the package structure 1 of this invention, the inductance element is first placed into the receiving space of the casing 32. Then, a plurality of coils to be connected are soldered to the upper ends 300 of the corresponding conductive terminals 30. Finally, the convex portions 3100 in the lid 31 are snapped into corresponding concave portions 3210 to complete the package process.

Since the package structure allows the inductance elements to be placed directly into the receiving space of the casing for soldering, the package can be downsized substantially, while still maintaining sufficient space for assembling and soldering the internal inductance devices therein. Due to the large space available for installation, this package structure is free of short-circuit failure in the coil even under the installation conditions of the lead-free IR process. Additionally, the installation of the inductance element in the receiving space provides for a more reliable fixation. Thus, disadvantages found in conventional package structures can be eliminated completely so that these package structures can also become increasingly lighter, slimmer, and smaller.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A package structure for use in an inductance element, comprising:
a casing having two opposite first sidewalls and two opposite second sidewalls, all of which defining a receiving space for receiving the inductance element;
a plurality of conductive terminals, each having an upper end and a lower end, the upper end extending from an upper portion of one of the first sidewall and being located in a recess defined by the two opposite sidewalls to electrically connect to the inductance element, the lower end extending from a lower portion of the first sidewall and being adapted to electrically connect to a circuit board;
a lid for covering the inductance element; and
a positioning device disposed between the lid and at lest one of the first sidewalls to position the lid onto the casing.

2. The package structure of claim 1, wherein the lid has two opposite first sides and two opposite second sides, the positioning device has a convex portion formed on at least one of the two first sides of the lid and a concave portion adapted to match with the convex portion, and the concave portion is formed on a top of the corresponding second sidewall.

3. The package structure of claim 2, wherein when the convex portion of the lid matches the concave portion of the second sidewalls, a distance is formed between one of the second sides of the lid and the conductive terminals.

4. The package structure of claim 1, wherein the upper portion of each of the conductive terminals extends from an upper surface of the first sidewall, and the lower portion of each of the conductive terminals extends from an lower surface of the first sidewall.

5. The package structure of claim 1, wherein the lid is a sheet-like structure.

6. The package structure of claim 1, wherein the circuit board is a printed circuit board.
